(19) United States
(12) Patent Application Publication
(10) Pub. No.: US 2026/0268718 A1
(43) Pub. Date: Sep. 10, 2026

(54) Method and Apparatus for Actuating a Motor Vehicle Closure Device

(71) Applicant: Bayerische Motoren Werke Aktiengesellschaft, Muenchen (DE)

(72) Inventors: Fanny Heidmann, Muenchen (DE); Daniel Kuelzer, Muenchen (DE)

(21) Appl. No.: 19/162,392

(22) PCT Filed: Jan. 24, 2024
(86) PCT No.: PCT/EP2024/051583

§ 371 Date: Sep. 4, 2025

(30) Foreign Application Priority Data
Mar. 13, 2023 (DE) 10 2023 106 114.3

(51) Int. Cl. G07C 9/37; B60K 15/05; G06N 20/00; G07C 9/00

(52) U.S. Cl. CPC G07C 9/37; B60K 15/05; G06N 20/00; G07C 9/00896; B60K 2015/0538

(57) ABSTRACT

A method for actuating a motor vehicle closure device of a motor vehicle includes providing a user profile for a person, wherein at least one trajectory assigned to the person for a filling process of an energy storage device is stored in the user profile. The method also includes detecting a first position of the person outside the motor vehicle at a first time and detecting a second position of the person outside the motor vehicle at a later time, using a detection device of the motor vehicle closure device. The method further includes determining a current trajectory of the person depending on at least the first position and the second position and comparing the current trajectory with the at least one trajectory assigned to the person. Depending on the comparison, a control signal is generated to open the motor vehicle closure device.

The present application is the U.S. national phase of PCT Application PCT/EP2024/051583 filed on Jan. 24, 2024, which claims priority of German patent application No. 10 2023 106 114.3 filed on Mar. 13, 2023, the entire contents of which are incorporated herein by reference.

### TECHNICAL FIELD

The disclosure relates generally to the field of motor vehicles, and more particularly to actuating a motor vehicle closure device of a motor vehicle.

### BACKGROUND

It is already known from the prior art that motor vehicle closures, for example fuel tank caps or charging caps, can be opened automatically or mechanically in order to gain access to a filling nozzle, for example. In particular at gas stations or charging stations, a corresponding nozzle can then be inserted into an opening in order to refuel the motor vehicle with electrical energy or fluid fuel, for example. Appropriate mechanical closure devices are already known for this purpose, which, for example, allow the cap to spring open, thus enabling easy access. However, this always requires the person to operate the fuel cap accordingly. In the case of a dirty vehicle, for example, this can result in the person getting dirty fingers.

DE 102009 058 864 B4 discloses a method for actuating the motor vehicle closure, which has a closure part that can be moved by means of a drive device and with which the mouth of a fuel filler neck can be closed, wherein switching on an activation device activates a sensor device which has a proximity sensor arranged in the vicinity of the closure part, wherein the activated sensor device sends an opening signal to the drive device to open the closure part when an approaching person and/or any approaching object falls below a predetermined distance from the proximity sensor, and that the activated sensor device sends a closing signal to the drive device to close the closure part when the person and/or object moves beyond the predetermined distance from the proximity sensor.

There is a need, however, for a motor vehicle closure device and method that provides convenient access for the person during a filling operation.

### SUMMARY

The above-described need, as well as others, are addressed by a motor vehicle closure device and method according to one or more embodiments disclosed herein.

One aspect of the disclosure relates to a method for actuating the motor vehicle closure device of a motor vehicle by means of the motor vehicle closure device. A user profile is provided for a person, wherein at least one trajectory assigned to the person for a filling process of an energy storage device of the motor vehicle is stored in the user profile by means of an electronic computing device of the motor vehicle closure device. A first position of the person outside the motor vehicle is detected at a first point in time, and a second position of the person outside the motor vehicle is detected at a second point in time, that is later than the first point in time, by means of a detection device of the motor vehicle closure device. The current trajectory of the person is determined depending on at least the first position and the second position by means of the electronic computing device. By means of the electronic computing device, the current trajectory is compared with the trajectory assigned to the person, and, depending on the comparison by means of the electronic computing device, a control signal is generated in order to open the motor vehicle closure device.

In particular, it is thus provided that trajectories are specified via the user profile, for example, which the user normally uses to move in the direction of the motor vehicle lock cover or the motor vehicle closure device, in particular during a refueling process or a charging process. These are stored both locally, in particular in the motor vehicle, and on a backend server, so that they can also be retrieved for other motor vehicles, for example. A current trajectory is now determined and compared with the stored trajectory. If these match, for example, it can be assumed that the user is now moving again towards the vehicle closure device for a filling operation. Based on the control signal in particular, the vehicle closure device, for example a vehicle closure lid of the vehicle closure device, can then be opened automatically, providing convenient access for the user.

This enables, in particular, so-called hands-free operation of the motor vehicle closure device.

In addition, an access authorization device, for example in the form of a key, in particular in the form of an electronic key, can also be tracked, and thus the movement or trajectory can be determined.

If the trajectory of the user indicates that they are moving toward the motor vehicle closure device, it can be recognized that, for example, a future refueling process is planned.

The motor vehicle can be either a motor vehicle with an internal combustion engine or a motor vehicle with an electric drive. It can also be a so-called hybrid vehicle. In particular, the motor vehicle with the internal combustion engine has, for example, a fuel filler cap, which in the present embodiment can then be regarded as a motor vehicle closure device. The energy storage device can then be designed as a tank. If the motor vehicle is designed as an electric motor vehicle, for example, the motor vehicle closure device can also be referred to as a charging cover. The energy storage device can then be designed as an electrical energy storage device, for example as a traction battery. If the motor vehicle is designed as a hybrid vehicle, for example, the motor vehicle can have both a corresponding fuel filler cap and a corresponding charging cap, as well as a corresponding fuel tank and a corresponding electrical energy storage device. In this case, it may also be provided that, for example, the position of the person relative to the charging flap or fuel filler cap, or their movement relative to the charging flap or fuel filler cap, is used to determine whether electrical charging or fluid charging is intended. For this purpose, the geolocation of the motor vehicle, a camera evaluation of the surroundings, or a historical filling history may be used.

Furthermore, it may also be provided that the fill level of the tank or electrical energy storage device can be taken into account. If, for example, the motor vehicle approaches an energy source but is almost full, it can be assumed that no refueling will take place. Thus, activation of the motor vehicle closure device can be suppressed. It is also possible to check whether, for example, the electrical energy storage device has been conditioned due to a search or input at a charging station, which would indicate a future charging process. Preconditioning by the user without a corresponding input at the charging station can also be taken into account.

In order to also cover cases in which, for example, the trajectory cannot be determined or compared, a mechanical opening of the motor vehicle closure device may also be provided. In particular, this allows convenient access for the user to the motor vehicle closure device.

In particular, it may also be provided that, if, for example, the motor vehicle is locked, the motor vehicle closure device may also be locked or closed. Furthermore, before the motor vehicle closure device can be opened at all, authentication or verification of the user or a person may also be carried out to determine whether they are authorized to perform the corresponding filling operation.

In particular, it can thus be regarded as one object of the disclosure that, even when the person approaches the motor vehicle closure device, opening of the motor vehicle closure device is suppressed if, for example, the trajectory detected by the during the approach is not a trajectory that is normally used by the user during a refueling process. Partial trajectories that indicate the filling process can also be used here.

Based on the detected current trajectory, which in particular describes a filling process, it is also possible to deduce the type of charging, for example DC charging or AC charging, as well as charging at a wall box a parking and configuration at the location. Furthermore, corresponding different specifications for countries can be taken into account. For example, the exit position of a driver of the motor vehicle can be taken into account on a country-specific basis, in particular whether, for example, left-hand traffic or right-hand traffic prevails and thus whether the driver sits on the left or right side.

In particular, at least some embodiments make use of the fact that the motor vehicle closure device can only be opened accordingly if a trajectory for the filling intention has been detected. The charging or filling-specific characteristics of the trajectory are utilized in this process. The electronic computing device can, for example, be designed to also learn and, for example, to continue to reliably detect future filling processes on the basis of the learned trajectories.

If the user is already in the vicinity of the filling nozzle, the vehicle closure device can also be actuated, in particular opened, independently of the user profile.

Furthermore, additional information regarding the filling process, in particular historical information, can also be accessed in the user profile. For example, a user-specific filling time, preferred filling locations, such as frequently used gas stations, the home wall box, or a wall box at work, can also be taken into account. In this case, a profile can be created that takes filling habits into account.

According to an advantageous embodiment, the electronic computing device is equipped with a machine learning algorithm, and the trajectory and/or the current trajectory are determined by means of the machine learning algorithm. In particular, this allows an initial user profile to be provided that can reliably record the user's individual movements and thus trajectories and adapt the initial user profile accordingly. This allows highly individual conclusions to be drawn about the filling process.

Furthermore, it has proven advantageous to additionally include a trajectory for removing a charging plug and/or charging cable from a storage device in the motor vehicle in the user profile. For example, the user can always position the charging cable or charging plug in the luggage compartment on the left rear side. Thus, a trajectory that follows the driver, for example, from the driver's seat to the luggage compartment and converges with a stop on the left side and then leads from the rear left side toward the fuel cap can be regarded as a trajectory that indicates a refueling process. Furthermore, specific, individual storage locations in the rear footwell area can also be used for the charging cable or charging plug, for example, in order to evaluate corresponding trajectories.

The fact that a charging process has taken place can be recognized, for example, by the fact that a corresponding charging cable has been plugged into the charging socket of the motor vehicle and, for example, electrical energy is flowing from the charging station to the motor vehicle. In particular, the associated historical trajectory can then be used, for example, to train the electronic computing device.

Furthermore, it has proven advantageous if, in addition, the control signal is only generated when the person is within a specified area in front of the motor vehicle closure device. For example, the specified area can be defined as 50 cm or one meter in front of the motor vehicle closure device. If the trajectory does not lead into this area, it can be assumed that no filling process is intended.

It has also proven advantageous if the control signal is only generated when the motor vehicle is in the vicinity of a charging station/gas station. For this purpose, a position detection device, for example in the form of a global positioning system, can be used to make appropriate use of both public charging stations and private charging stations, for example at the wall box. Furthermore, gas stations can also be used as corresponding filling stations. In addition, based on further detection devices, for example optical detection devices, both a charging station and a gas station can be identified accordingly, and the control signal can be generated only if such a gas station or charging station is present.

Another advantageous embodiment provides for the user profile to take into account an individual sequence of steps in the charging process to determine the trajectory. For example, it may be provided that, after removing the charging cable, the user always first plugs the charging cable into the charging station and only then into the motor vehicle, or vice versa. This corresponding sequence of steps can now be taken into account in order to create the individual user profile and thus reliably infer the individual charging process.

Furthermore, it has proven advantageous to take the current position of the motor vehicle into account when generating the control signal. For this purpose, a position detection device, for example in the form of a global positioning system, can be used to make appropriate use of both public charging stations and private charging stations, for example at the wall box.

Another advantageous embodiment provides for specific changes in direction of the person for a filling process to be evaluated when comparing the current trajectory with the trajectory. For example, corresponding changes in direction of the trajectory, for example when getting in and out of the vehicle, when removing the charging plug, and when plugging the charging plug into the motor vehicle or charging station, can be evaluated so that the filling process can be reliably inferred. In particular, it can also be taken into account whether the motor vehicle is located near a charging station or a home wall box.

The method presented is, in particular, a computer-implemented method. Therefore, a further aspect relates to a computer program product with program code means which cause an electronic computing device, when the program code means are processed by the electronic computing device, to perform a method according to the preceding aspect. Another aspect therefore also relates to a computer-readable storage medium containing the computer program product.

Furthermore, at least one embodiment is a motor vehicle closure device for a motor vehicle, with at least one detection device and an electronic computing device, wherein the motor vehicle closure device is designed to carry out a method according to the preceding aspect. In particular, the method is carried out by means of the motor vehicle closure device.

The electronic computing device has, for example, processors, circuits, in particular integrated circuits, and other electronic components in order to be able to carry out the corresponding method steps.

Furthermore, the disclosure also relates to a motor vehicle with a motor vehicle closure device. The motor vehicle can be designed as a partially autonomous motor vehicle or as a fully autonomous motor vehicle.

Advantageous embodiments of the method are to be regarded as advantageous embodiments of the computer program product, the computer-readable storage medium, the motor vehicle closure device, and the motor vehicle. The motor vehicle closure device and the motor vehicle have specific features that enable them to perform the corresponding method steps.

Further features can be found in the claims, the FIGURES, and the description of the figures. The features and combinations of features mentioned above in the description, as well as the features and combinations of features mentioned below in the description of the figures and/or shown in the FIGURES alone, can be used not only in the combination specified in each case, but also in other combinations or on their own.

The above-described features and advantages, as well as others, will become more readily apparent to those of ordinary skill in the art by reference to the following detailed description and accompanying drawings.

### BRIEF DESCRIPTION OF THE DRAWINGS

FIG. 1 shows a schematic plan view of an embodiment of a motor vehicle with an embodiment of a motor vehicle closure device.

### DETAILED DESCRIPTION

In the FIGURE, like or functionally like elements are provided with the same reference signs.

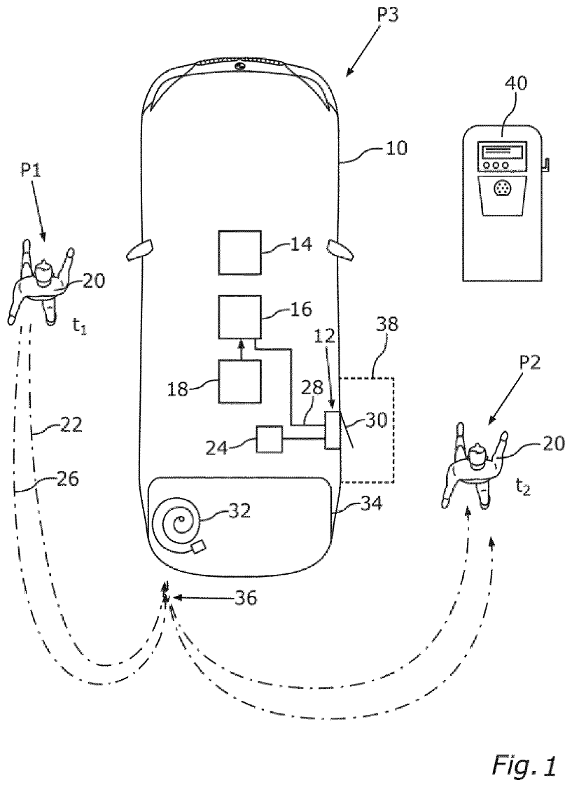

FIG. 1 shows a schematic plan view of an embodiment of a motor vehicle 10 with an embodiment of a motor vehicle closure device 12. The motor vehicle closure device 12 has at least one detection device 14, for example in the form of a camera. Furthermore, the motor vehicle closure device 12 has at least one electronic computing device 16.

In the presented method for actuating the motor vehicle closure device 12, it is provided that a user profile 18 is made available for a person 20, wherein at least one trajectory 22 assigned to the person 20, which is shown here as a dotted line, for a filling process of an energy storage device 24 of the motor vehicle 10 is stored by means of the electronic computing device 16. A first position P1 of the person 20 outside the motor vehicle 10 is detected at a first point in time t₁ and at least a second position P2 of the person 20 outside the motor vehicle 10 is detected at a second point in time t₂, which is later than the first point in time t₁, by means of the detection device 14. By means of the electronic computing device 16, the current trajectory 26 of the person 20 is determined depending on at least the first position P1 and the second position P2, wherein the current trajectory is shown here as a dashed line.

The current trajectory 26 is compared with the trajectory 22 assigned to the person 20 by means of the electronic computing device 16, and a control signal 28 is generated to open the motor vehicle closure device 12, for example a charging cover 30, depending on the comparison by means of the electronic computing device 16.

In particular, it may be provided that the electronic computing device 16 has a machine learning algorithm and that the trajectory 22 and/or the current trajectory 26 is determined by means of the machine learning algorithm.

In addition, FIG. 1 shows that the user profile 18 takes into account a trajectory for removing a charging plug 32 and/or the charging cable from a storage device 34, in this case in particular a luggage compartment of the motor vehicle 10. Furthermore, it is specifically provided that, in the case of user profile 18, an individual sequence of steps of the charging process is taken into account in order to determine the trajectory 22 or the current trajectory 26. Furthermore, it may also be provided that, when comparing the current trajectory 22 with the trajectory 26, a change of direction 36 of the person 20 for a filling process is evaluated or taken into account.

Furthermore, FIG. 1 shows that the control signal 28 is only generated when the person 20 is located in a predetermined area 38 in front of the motor vehicle closure device 12. Furthermore, the control signal 28 can only be generated if the motor vehicle 10 is located near a charging station 40 or filling station for fluid fuel. In addition, the current position P3 of the motor vehicle 10 can also be taken into account when generating the control signal 28.

In particular, it may thus be provided that, for example, the trajectory comparison is triggered as soon as the person 20 enters the predetermined area 38. In this way, so-called false positive opening operations can be prevented in particular.

Furthermore, stops or changes of direction 36 in the current trajectory 26 can also be determined, which serve as an indicator that the user 20 is starting a filling process. In particular, the position and duration of these stops and changes of direction 36 can serve as information that a filling process is taking place. Machine learning algorithms, which use this as an input parameter, can be used for this purpose. Furthermore, the charging station 40 can also be detected on the basis of the detection device 14, for example, using computer vision technologies. This camera information can then also be used to reliably determine a charging process. In addition, the environment can also be detected using ultrasonic sensors, for example, and the charging station 40 can be detected accordingly.

In particular, an additional objective may be to learn the position of a wall box over time relative to the motor vehicle 10 or the parking space, which can be done in particular on the basis of the use of this wall box. This can be done in particular on the basis of the principles mentioned above.

Furthermore, additional signals, such as door signals, for example, the opening of the driver's door, the opening of the luggage compartment, or the like, can also be used to infer the filling process. Furthermore, so-called geofence information, such as where the motor vehicle is currently located and whether it is within the geofence of a home wall box or a gas station, can also be used accordingly. In addition, further information from the charging station 40 can also be used, such as the charging type, a terminal position, and a parking configuration.

### LIST OF REFERENCE SIGNS

10 motor vehicle
12 motor vehicle closure device
14 detection device
16 electronic computing device
18 user profile
20 person
22 trajectory
24 energy storage device
26 current trajectory
28 control signal
30 charging cover
32 charging cable
34 luggage compartment
36 change of direction
38 predetermined area
40 charging station
P1 first position
P2 second position
P3 current position
t₁ first point in time
t₂ second point in time

1.-10. (canceled)

11. A method for actuating a motor vehicle closure device of a motor vehicle, said method comprising the steps of:
providing a user profile for a person, wherein at least one trajectory assigned to the person for a filling process of an energy storage device of the motor vehicle is stored in the user profile using an electronic computing device of the motor vehicle closure device;
detecting a first position of the person outside the motor vehicle at a first point in time and detecting a second position of the person outside the motor vehicle at a second point in time, that is later than the first point in time, using a detection device of the motor vehicle closure device;
determining, using the electronic computing device, a current trajectory of the person depending on at least the first position and the second position;
comparing, using the electronic computing device, the current trajectory with the at least one trajectory assigned to the person; and
depending on the comparison, generating a control signal to open the motor vehicle closure device.

12. The method as claimed in claim 11, wherein the electronic computing device has a machine learning algorithm and at least one of the trajectory or the current trajectory is determined using the machine learning algorithm.

13. The method as claimed in claim 12, wherein a trajectory for removing a charging plug or a charging cable from a storage device of the motor vehicle is additionally taken into account in the user profile.

14. The method as claimed in claim 11, wherein a trajectory for removing a charging plug or a charging cable from a storage device of the motor vehicle is additionally taken into account in the user profile.

15. The method as claimed in claim 11, wherein generating the control signal further comprises generating the control signal depending at least in part on whether the person is located in a predetermined area with respect to the motor vehicle closure device.

16. The method as claimed in claim 15, wherein a current position of the motor vehicle is taken into account when generating the control signal.

17. The method as claimed in claim 15, wherein generating the control signal further comprises generating the control signal depending at least in part on whether the motor vehicle is located near a charging station.

18. The method as claimed in claim 11, wherein generating the control signal further comprises generating the control signal depending at least in part on whether the motor vehicle is located near a charging station.

19. The method as claimed in claim 11, wherein the user profile takes into account an individual step sequence of the charging process for determining the trajectory or the current trajectory.

20. The method as claimed in claim 19, wherein a current position of the motor vehicle is taken into account when generating the control signal.

21. The method as claimed in claim 11, wherein a current position of the motor vehicle is taken into account when generating the control signal.

22. The method as claimed in claim 11, wherein, when comparing the current trajectory with the trajectory, specific changes of direction of the person are evaluated for a filling process.

23. The method of as claimed in claim 11, further comprising opening the motor vehicle closure device in response to receiving the control signal.

24. A motor vehicle closure device for a motor vehicle, with at least one detection device and an electronic computing device, wherein the motor vehicle closure device is configured to perform the method as claimed in claim 23.

25. A non-transitory computer readable medium containing program code which cause an electronic computing device to perform a method as claimed in claim 11 when the program code is processed by the electronic computing device.

26. A motor vehicle closure device for a motor vehicle, with at least one detection device and an electronic computing device, wherein the motor vehicle closure device is configured to perform a method as claimed in claim 11.
